(19) United States
(12) Patent Application Publication
(10) Pub. No.: US 2022/0069403 A1
(43) Pub. Date: Mar. 3, 2022

(54) BATTERY CASING CONTAINING HIGH-VOLTAGE BATTERY

(71) Applicants: HYUNDAI MOTOR COMPANY, Seoul (KR); KIA MOTORS CORPORATION, Seoul (KR)

(72) Inventors: Hae Kyu Lim, Bucheon-si (KR); Ji Woong Jung, Anyang-si (KR); In Gook Son, Hwaseong-si (KR); Gyung Hoon Shin, Seoul (KR); Yu Ri Oh, Hwaseong-si (KR); Jong Wook Lee, Hwaseong-si (KR); Yong Hwan Choi, Seoul (KR); Tae Hyuck Kim, Asan-si (KR)

(21) Appl. No.: 17/153,053

(22) Filed: Jan. 20, 2021

(30) Foreign Application Priority Data
Aug. 25, 2020 (KR) 10-2020-0107330

(51) Int. Cl. H01M 50/242; H01M 50/249; H01M 50/186

(52) U.S. Cl. CPC H01M 50/242; H01M 50/186; H01M 50/249

(57) ABSTRACT

A battery casing contains a high-voltage battery. Load paths are formed around a high-voltage connector in the occurrence of collision in order to prevent the high-voltage connector from being damaged. Portions including the surroundings of the high-voltage connector have strength against collision, thereby ensuring reliability against collision.

### CROSS REFERENCE TO RELATED APPLICATIONS

The present application claims priority to Korean Patent Application No. 10-2020-0107330, filed Aug. 25, 2020, the entire contents of which is incorporated herein for all purposes by this reference.

### BACKGROUND

### Field

The present disclosure generally relates to a battery casing containing a high-voltage battery and, more particularly, to a battery casing containing a high-voltage battery, the battery casing having a structure able to prevent a high-voltage connector from being damaged in a collision.

### Description of the Related Art

Recently, there has been increased interest in environmental vehicles because of environmental issues, high petroleum prices, and the like. A variety of driving modules using electric energy have been developed.

For example, in the automobile industry, battery powered vehicles or electric vehicles (EVs), fuel cell vehicles using fuel cells as a power source of a motor, and hybrid vehicles using a motor and an engine, and the like have been developed.

In particular, an electric vehicle is provided with a battery module storing electric energy. The battery module includes a plurality of battery cell units accommodated within a battery housing. Such a battery module must be able to prevent the battery cell units from being damaged by external impact.

Accordingly, a battery casing containing the battery module is configured to protect the battery module in the occurrence of collision. In particular, in the battery casing, a high-voltage connector for electrical connection of the battery module is exposed. Since the high-voltage connector protrudes from the battery casing, in the occurrence of collision, any other component, such as a suspension, may strike and damage the high-voltage connector, thereby causing a fire danger.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a battery casing containing a high-voltage battery, the battery casing having a structure able to prevent a high-voltage connector from being damaged in the occurrence of collision, so that the reliability of the high-voltage connector is obtained.

In order to achieve the above objective, according to one aspect of the present disclosure, there is provided a battery casing containing a high-voltage battery. The battery casing may include a battery floor including side seals disposed on lateral portions to extend in a longitudinal direction, a front seal extending in a transverse direction intersecting the side seals to connect the side seals, and a connector provided in front of the front seal and connected to electric components including batteries, an extension floor including side members connected to a front end of the battery floor and coupled to the side seals to form load paths and a front member extending in a lateral direction to connect the side members and having an open area in a portion facing the connector, and a reinforcing structure disposed in the open area of the extension floor to surround the connector and is disposed to support the front seal and the front member, thereby forming the load paths.

The opposite side members of the extension floor may extend forward from the side seals while being inclined inward, and the front member is coupled to distal ends of the side members.

A lower end of the extension floor may be open downwardly in a top-bottom direction, thereby forming a space portion.

The space portion may extend in a length greater than the width of the connector, and a range from the front member to the connector may be open.

The extension floor may include a cover on a bottom thereof, the cover being detachably attached to the space portion to close the space portion.

The battery casing may further include a plurality of reinforcing members disposed in a longitudinal direction of the front seal such that the reinforcing members are spaced apart from each other, the reinforcing members extend forward from the front seal to connect to the side members or the front member, thereby forming the load paths.

The reinforcing structure may include a plurality of reinforcing portions provided in a longitudinal direction of the front seal, disposed on opposite sides of the connector, and coupled to the front seal, and a reinforcement bracket configured to surround the connector and connected to the reinforcing portions and the front member, thereby forming the load paths.

Each of the reinforcing portions may include a first reinforcing section coupled to the reinforcement bracket and a second reinforcing section coupled to the front seal, the first reinforcing section extending further away from the battery floor than the second reinforcing section.

A front end of the lower portion of the first reinforcing section may be inclined backward. A front end of the upper portion of the first reinforcing section may be inclined backward and connected to the second reinforcing section.

The reinforcement bracket may include a pair of sidewalls facing each other, spaced apart from each other a distance greater than the width of the open area, and coupled to the front member, and a connecting portion connecting the sidewalls, coupled to the reinforcing portions, and allowing the connector to extend therethrough.

The sidewalls of the reinforcement bracket and the reinforcing portions may be disposed on a straight line in a front-back direction.

Since the battery casing containing a high-voltage battery has the above-described structure, the load paths are formed around the high-voltage connector in the occurrence of collision in order to prevent the high-voltage connector from being damaged. Since portions including the surroundings of the high-voltage connector have strength against collision, reliability against collision is provided.

### BRIEF DESCRIPTION OF THE FIGURES

The above and other objectives, features, and other advantages of the present disclosure will be more clearly understood from the following detailed description when taken in conjunction with the accompanying drawings, in which:

FIGS. 1, 2, and 3 are views illustrating a battery casing containing a high-voltage battery according to the present disclosure;

FIG. 4 is a view illustrating load paths of the battery casing illustrated in FIG. 1; and

FIGS. 5 and 6 are views illustrating a reinforcing structure of the battery casing illustrated in FIG. 1.

### DETAILED DESCRIPTION

Hereinafter, a battery casing containing a high-voltage battery according to an exemplary embodiment of the present disclosure will be described in detail with reference to the accompanying drawings.

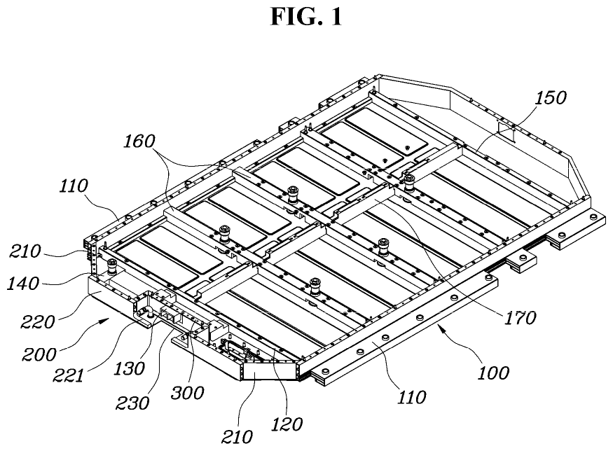

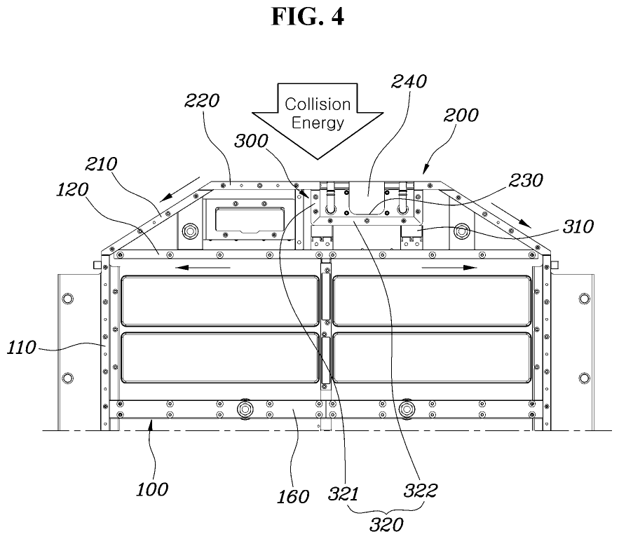

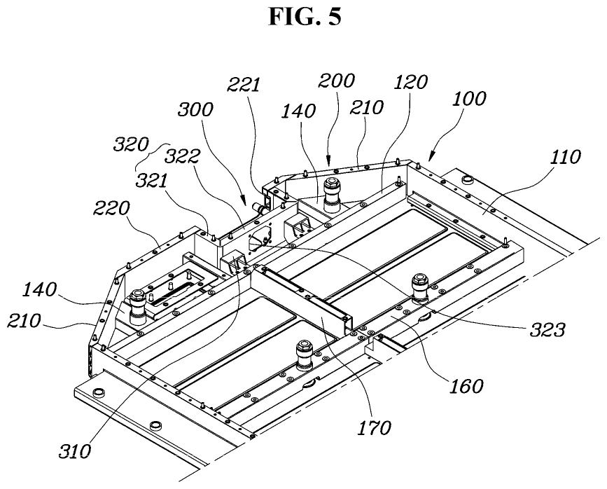

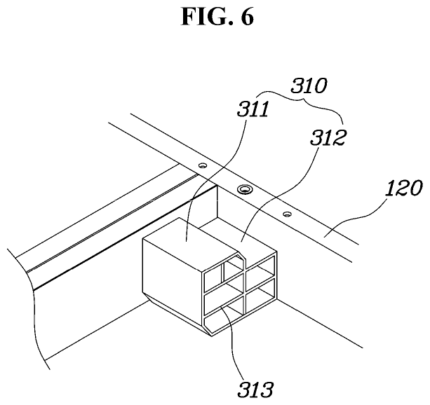

FIGS. 1 to 3 are views illustrating a battery casing containing a high-voltage battery according to the present disclosure, FIG. 4 is a view illustrating load paths of the battery casing illustrated in FIG. 1, and FIGS. 5 and 6 are views illustrating a reinforcing structure of the battery casing illustrated in FIG. 1.

As illustrated in FIGS. 1 to 6, the battery casing containing a high-voltage battery according to the present disclosure includes a battery floor 100, an extension floor 200, and a reinforcing structure 300. The battery floor 100 includes side seals 110 disposed on lateral portions to extend in a longitudinal direction, a front seal 120 extending in a transverse direction intersecting the side seals 110 to connect the side seals 110, and a connector 130 provided in front of the front seal 120. The connector 130 is connected to electric components, such as batteries. The extension floor 200 includes side members 210 connected to the front end of the battery floor 100 and coupled to the side seals 110 to form load paths and a front member 220 extending in a lateral direction to connect the side members 210 and having an open area 221 in a portion facing the connector 130. The reinforcing structure 300 is disposed in the open area 221 of the extension floor 200 to surround the connector 130 and is disposed to support the front seal 120 and the front member 220, thereby forming the load paths.

In this manner, the battery casing according to the present disclosure includes the battery floor 100, the extension floor 200, and the reinforcing structure 300. Here, the battery floor 100 includes the side seals 110 disposed on opposite sides thereof and the front seal 120 disposed in front of the side seals 110 to connect the side seals 110. The battery floor 100 may further include an end seal 150 provided at the rear of the side seals 110. A plurality of cross members 160 may be provided between the front seal 120 and the side seals 110. A center chamber 170 connecting the cross members 160 may be provided. Accordingly, electric components including a battery may be mounted on the battery floor 100.

The extension floor 200 is coupled to the front end of the battery floor 100. When the connector 130 is provided at the rear of the end seal 150, the extension floor 200 may be provided on the end of the battery floor 100.

The extension floor 200 includes the side members 210 coupled to the side seals 110, and the front member 220 connecting the side members 210. The side members 210 of the extension floor 200 are coupled to the side seals 110 of the battery floor 100 as described above, thereby forming the load paths on which a collision-induced load is distributed to the front member 220, the side members 210, the front seal 120, and the side seals 110. In addition, in the front member 220 of the extension floor 200, the open area 221 is formed in a portion facing the connector 130, so that the connector 130 is exposed to the front through the open area 221. In this manner, the open area 221 is formed in the front member 220 to be open to the front of the connector 130, thereby facilitating the connection external electrical lines to the connector 130. In addition, an operation of the connector 130 may be performed through the open area 221.

In addition, the reinforcing structure 300 is provided inside the extension floor 200, thereby reinforcing the strength of the surroundings of the open area 221 in which the connector 130 is provided. The reinforcing structure 300 is disposed in the open area 221 of the extension floor 200 while being configured to surround the connector 130, thereby protecting the connector 130 so as not to be struck by other components in collision. In addition, the reinforcing structure 300 is disposed to be supported by the front seal 120 and the front member 220 to form the load paths. In the case of front collision, a collision-induced load is distributed to the front member 220, the reinforcing structure 300, and the front seal 120, so that the load paths provide strength against collision. Accordingly, even in the case of front collision, the connector 130 may be prevented from being impacted by other components. The collision-induced load may be distributed by the load paths of the extension floor 200, the reinforcing structure 300, and the battery floor 100, thereby safely protecting electric components including the battery.

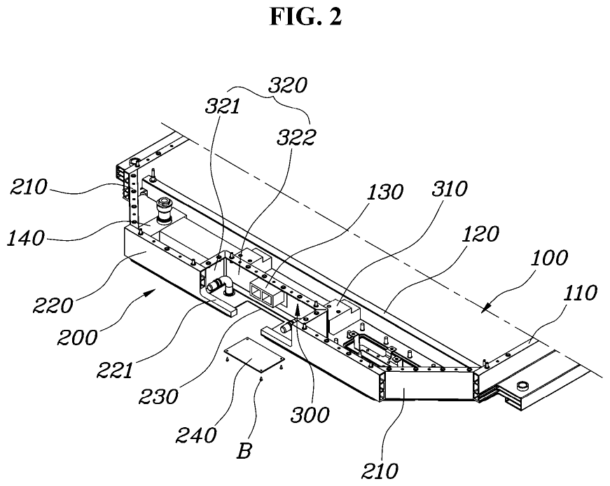

Describing the above-described battery casing according to the present disclosure in more detail, as illustrated in FIGS. 2 and 4, the opposite side members 210 of the extension floor 200 extend forward from the side seals 110 while being inclined inward, and the front member 220 is coupled to distal ends of the side members 210.

That is, the side members 210 of the extension floor 200 extend on oblique lines defining acute angles with respect to the front seal 120, and the front member 220 is coupled to the distal ends of the side members 210. Thus, load generated in collision may be properly distributed to the front seal 120 and the side seals 110 of the front member 220. In addition, since the side members 210 extend while being inclined inward, strength against front collision is provided, and strength against front-side collision is also increased.

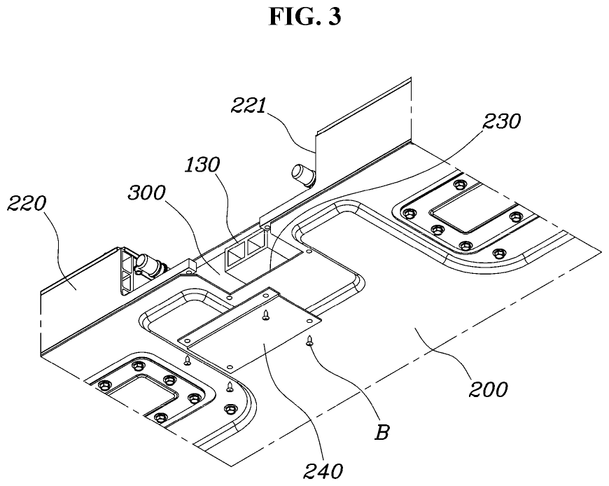

Here, the lower end of the extension floor 200 may be open downwardly of the open area 221 in a top-bottom direction, thereby forming a space portion 230. As illustrated in FIG. 3, since the extension floor 200 has the space portion 230 below the open area 221, the connector 130 is exposed from below the extension floor 200 through the space portion 230. In this manner, the extension floor 200 has the open area 221 and the space portion 230 below the open area 221, such that connector 130 is exposed. Accordingly, other components, such as electrical lines, may be easily connected to the connector 130. The space portion 230 extends from the front member 220 to the connector 130, with the length thereof being greater than the width of the connector 130, and the range from the front member 220 to the connector 130 is open, such that the connector 130 is exposed to the front and below. That is, when the length of the space portion 230 is shorter than the width of the connector 130, the space for the connector 130 is limited. Accordingly, the length of the space portion 230 is determined to be greater than the width of the connector 130 and the range from the front member 220 to the connector 130 is open, such that a tool or a hand of a mechanic may easily reach the connector 130.

That is, in general, the battery casing is mounted on the bottom of a vehicle, and the vehicle is lifted up when working with the battery casing, such that a mechanic must work below the battery casing. Consequently, the extension floor 200 has the space portion 230 below the open area 221, such that the mechanic may easily work with the connector 130 by putting a hand or a tool into the open area 221 and the space portion 230. Accordingly, since the mechanic may work with the connector 130 through the open area 221 and the space portion 230, work convenience may be ensured.

Here, a cover 240 may be provided on the bottom of the extension floor 200. The cover 240 may be detachably attached to the space portion 230 to close the space portion 230. Since the cover 240 is mounted on the space portion 230 of the extension floor 200, the connector 130 is protected from foreign matter-induced contamination or impact applied from below the extension floor 200. In addition, since the cover 240 occupies and closes the space portion 230, strength reduction caused by a hollow space of the space portion 230 may be prevented, thereby increasing the overall strength of the extension floor 200. In addition, the cover 240 may be detachably attached to the bottom of the extension floor 200 using bolts or rivets B, such that the cover 240 may be detached from the extension floor 200 according to whether or not the connector 130 is worked with.

In addition, as illustrated in FIGS. 4 and 5, the battery floor 100 may further include a plurality of reinforcing members 140 disposed in the longitudinal direction of the front seal 120 such that the reinforcing members 140 are spaced apart from each other. The reinforcing members 140 extend forward from the front seal 120 to be connected to the side members 210 or the front member 220, thereby forming the load paths.

Since the front seal 120 and the side members 210 or the front seal 120 and the front member 220 are connected via the reinforcing members 140 as described above, a connection structure for the respective members may be firmer and the respective members may maintain a more reliable connection state. In addition, since the load paths are formed on the front member 220 and the front seal 120 or the side members 210 and the front seal 120 by the reinforcing members 140, a collision-induced load may be distributed and performance against collision may be improved. The reinforcing members 140 may extend to intersect the extension floor 200 in the longitudinal direction and be disposed to be spaced apart from a variety of electric components and a reinforcement bracket 320.

In addition, as illustrated in FIGS. 5 and 6, the reinforcing structure 300 may include a plurality of reinforcing portions 310 provided in the longitudinal direction of the front seal 120, disposed on opposite sides of the connector 130, and coupled to the front seal 120; and the reinforcement bracket 320 configured to surround the connector 130 and connected to the reinforcing portions 310 and the front member 220, thereby forming the load paths.

The reinforcing structure 300 serves to protect the connector 130 in collision, and includes the reinforcing portions 310 and the reinforcement bracket 320 to prevent impact from being applied to the connector 130. That is, the reinforcement bracket 320 is coupled to the front member 220 to distribute the collision-induced load and is formed of a rigid body, thereby protecting the connector 130 from direct impact. The reinforcing portions 310 are disposed on opposite sides of the connector 130 and coupled to the reinforcement bracket 320 and the front seal 120, thereby forming the load paths. Consequently, a collision-induced load may be distributed to the front member 220, to the reinforcement bracket 320, to the reinforcing portions 310, and to the front seal 120, thereby preventing the connector 130 from being damaged by collision.

In particular, each of the reinforcing portions 310 may include a first reinforcing section 311 coupled to the reinforcement bracket 320 and a second reinforcing section 312 coupled to the front seal 120. The first reinforcing section 311 may extend further away from the battery floor than the second reinforcing section 312. The first reinforcing section 311 and the second reinforcing section 312 may be shaped to form a closed cross-section, with flanges 313 extending to intersect the internal spaces thereof. The first reinforcing section 311 and the second reinforcing section 312 may be integrally provided. The first reinforcing section 311 is longer than the second reinforcing section 312, such that, when a collision occurs, a deformation in the first reinforcing section 311 may be induced on the second reinforcing section 312. That is, since first reinforcing section 311 is longer than the second reinforcing section 312, in the case of front collision, the first reinforcing section 311 is bent and deformed on the second reinforcing section 312. Consequently, the front member 220 is deformed and the reinforcement bracket 320 is moved backward, a load caused by front collision may be efficiently canceled.

Here, the front end of the lower portion of the first reinforcing section 311 may be inclined backward, and the front end of the upper portion of the first reinforcing section 311 may be inclined backward and be connected to the second reinforcing section 312. That is, since the front end of the lower portion of the first reinforcing section 311 is inclined backward as illustrated in FIG. 6, in the occurrence of a front collision, the upper portion of the first reinforcing section 311 is caused to be bent. Since the rear end of the upper portion of the first reinforcing section 311 is inclined backward, supporting force against load caused by front collision may be obtained to efficiently cancel the collision-induced load. In this manner, each of the reinforcing portions 310 may have the shape of a symbol “ [symbol] ”, due to the first reinforcing section 311 and the second reinforcing section 312. The reinforcing portions 310 may support load caused by front collision and efficiently cancel the load through deformation, thereby preventing the connector 130 from being damaged.

In addition, as illustrated in FIG. 5, the reinforcement bracket 320 may include a pair of sidewalls 321 facing each other, spaced apart from each other a distance greater than the width of the open area 221, and coupled to the front member 220; and a connecting portion 322 connecting the sidewalls 321, coupled to the reinforcing portions 310, and allowing the connector 130 to extend therethrough. That is, since the reinforcement bracket 320 includes the pair of sidewalls 321 and the connecting portion 322 connecting the sidewalls 321, the reinforcement bracket 320 has an open cross-section, with one side thereof being open. The reinforcement bracket 320 may be disposed such that the open portion thereof is matched to the open area 221 of the extension floor 200. Here, the sidewalls 321 may be coupled to the front member 220 while being spaced apart from each other a distance greater than the width of the open area 221. The connecting portion 322 connecting the sidewalls 321 has a through-hole 323, such that the connector 130 may be exposed to the front through the through-hole 323. The through-hole 323 may be configured to be matched to the connector 130 such that the connector 130 is firmly fixed or to be greater than the connector 130 such that a movement caused by the deformation in the reinforcing portions 310 may be absorbed.

In addition, the sidewalls 321 of the reinforcement bracket 320 and the reinforcing portions 310 are disposed on a straight line in the front-back direction, such that the sidewalls 321 and the reinforcing portions 310 form the load paths. In this manner, a collision-induced load may be efficiently transferred.

Since the battery casing containing a high-voltage battery has the above-described structure, the load paths are formed around the high-voltage connector 130 in the occurrence of impact in order to prevent the high-voltage connector 130 from being damaged. Since portions including the surroundings of the high-voltage connector 130 have strength against collision, reliability against collision is provided.

Although the specific embodiment of the present disclosure has been described for illustrative purposes, those skilled in the art will appreciate that various modifications, additions and substitutions are possible, without departing from the scope and spirit of the disclosure as disclosed in the accompanying claims.

1. A battery casing containing a high-voltage battery, the battery casing comprising:
a battery floor comprising side seals disposed on lateral portions of the battery floor to extend in a longitudinal direction, a front seal extending in a transverse direction intersecting the side seals to connect the side seals, and a connector provided in front of the front seal and connected to electric components, including batteries;
an extension floor comprising side members connected to a front end of the battery floor and coupled to the side seals to form load paths, and comprising a front member extending in a lateral direction to connect the side members and having an open area in a portion facing the connector; and
a reinforcing structure disposed in the open area of the extension floor to surround the connector, the reinforcing structure being disposed to support the front seal and the front member, thereby forming the load paths.

2. The battery casing according to claim 1, wherein the opposite side members of the extension floor extend forward from the side seals while being inclined inward, and the front member is coupled to distal ends of the side members.

3. The battery casing according to claim 1, wherein a lower end of the extension floor is open downwardly in a top-bottom direction, thereby forming a space portion.

4. The battery casing according to claim 3, wherein the space portion extends in a length greater than the width of the connector, and a range from the front member to the connector is open.

5. The battery casing according to claim 3, wherein the extension floor comprises a cover on a bottom thereof, the cover being detachably attached to the space portion to close the space portion.

6. The battery casing according to claim 1, further comprising:
a plurality of reinforcing members disposed in a longitudinal direction of the front seal such that the reinforcing members spaced apart from each other, the reinforcing members extending forward from the front seal to connect to the side members or the front member, thereby forming the load paths.

7. The battery casing according to claim 1, wherein the reinforcing structure comprises:
a plurality of reinforcing portions provided in a longitudinal direction of the front seal, disposed on opposite sides of the connector, and coupled to the front seal; and
a reinforcement bracket configured to surround the connector, and connected to the reinforcing portions and the front member, thereby forming the load paths.

8. The battery casing according to claim 7, wherein each of the reinforcing portions comprises a first reinforcing section coupled to the reinforcement bracket and a second reinforcing section coupled to the front seal, the first reinforcing section extending further away from the battery floor than the second reinforcing section.

9. The battery casing according to claim 8, wherein a front end of the lower portion of the first reinforcing section is inclined backward, and a front end of the upper portion of the first reinforcing section is inclined backward and connected to the second reinforcing section.

10. The battery casing according to claim 7, wherein the reinforcement bracket comprises:
a pair of sidewalls facing each other, spaced apart from each other a distance greater than the width of the open area, and coupled to the front member; and
a connecting portion connecting the sidewalls, coupled to the reinforcing portions, and allowing the connector to extend therethrough.

11. The battery casing according to claim 10, wherein the sidewalls of the reinforcement bracket and the reinforcing portions are disposed on a straight line in a front-back direction.
